(19) United States
(12) Patent Application Publication
(10) Pub. No.: US 2008/0180420 A1
(43) Pub. Date: Jul. 31, 2008

(54) MULTIMODE-COMPRESSIVE OVERDRIVE CIRCUIT AND ASSOCIATED METHOD

(76) Inventor: Chung-Yi Chen, Nantou County (TW)

Correspondence Address: NORTH AMERICA INTELLECTUAL PROPERTY CORPORATION, P.O. BOX 506, MERRIFIELD, VA, 22116, US

(21) Appl. No.: 12/020,588

(22) Filed: Jan. 28, 2008

Related U.S. Application Data
(60) Provisional application No. 60/886,953, filed on Jan. 29, 2007.

(51) Int. Cl. G06F 3/038

(52) U.S. Cl. 345/204

(57) ABSTRACT

A multimode-compressive overdrive circuit includes a plurality of calculation units, a determination unit and a multimode encoding unit. The calculation units receive display data, and generate a plurality of image error values according to a plurality of compression modes. The determination unit, coupled to the calculation units, generates a best-compression mode signal according to the image error values. The multimode encoding unit, coupled to the determination unit, multimode-compresses the display data in response to the best-compression mode signal.

### CROSS REFERENCE TO RELATED APPLICATIONS

This application claims the benefit of U.S. Provisional Application No. 60/886,953, which was filed on Jan. 29, 2007 and entitled “OVERDRIVE COMPRESSION”.

### BACKGROUND OF THE INVENTION

1. Field of the Invention

The present invention relates to image processing of an LCD (liquid crystal display), and more particularly, to a multimode-compressive overdrive circuit and associated method.

2. Description of the Prior Art

An LCD has the advantages of being small-sized and light-weight, therefore, LCDs are gradually substituting for conventional cathode ray tube displays. As the display image content changes, however, liquid crystal molecules cannot quickly rotate to a desired angle with changes in the image content, causing an image blur problem. More particularly, the image blur problem is much more serious when a difference of the pixel values between adjacent frames is large.

In order to deal with the image blur problem, the conventional overdrive circuit requires buffers for buffering frame data to perform overdrive processing. As the display resolution increases, however, more storage spaces of buffers are required. Thus, material costs will increase since the storage spaces and/or the amount of buffers should be increased. Therefore, there is a need for improving the conventional overdrive circuit.

### SUMMARY OF THE INVENTION

It is therefore an objective of the claimed invention to provide a multimode-compressive overdrive circuit and associated method to solve the above-mentioned problem.

The claimed invention discloses a multimode-compressive overdrive circuit comprising a plurality of calculation units, a determination unit and a multimode encoding unit. The calculation units receive display data, and generate a plurality of image error values according to a plurality of compression modes. The determination unit, coupled to the calculation units, generates a best-compression mode signal. The multimode encoding unit, coupled to the determination unit, multimode-compresses the display data in response to the best-compression mode signal.

The claimed invention further discloses a multimode-compressive overdrive method, including steps of: reading display data, calculating a plurality of image error values corresponding to a plurality of compression modes, respectively, determining a best-compression mode according to the image error values, and multimode-compressing according to the best-compression mode to generate compression data. According to an embodiment, the method further comprises utilizing a first-in first-out (FIFO) memory to read the compression data, and multimode-decompressing the compression data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a multimode-compressive overdrive circuit according to one embodiment of the present invention.

FIG. 2 illustrates the multimode compressor shown in FIG. 1.

FIG. 3 illustrates the multimode de-compressor shown in FIG. 1.

FIG. 4 illustrates pixels processed by a multimode-compressive overdrive method according to one embodiment of the present invention.

FIG. 5 is a flowchart of a multimode-compressive overdrive method according to one embodiment of the present invention.

### DETAILED DESCRIPTION

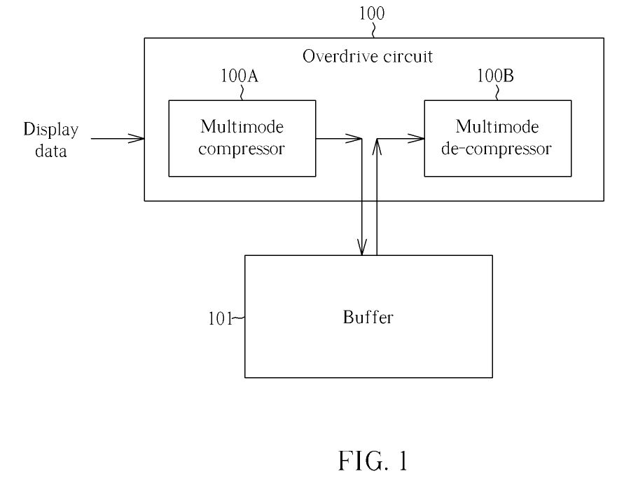

Please refer to FIG. 1 showing a diagram of a multimode-compressive overdrive circuit 100 according to one embodiment of the present invention, comprising a multimode compressor 100A and a multimode de-compressor 100B respectively coupled to a buffer 101. The buffer 101 can be a dynamic random access memory (DRAM).

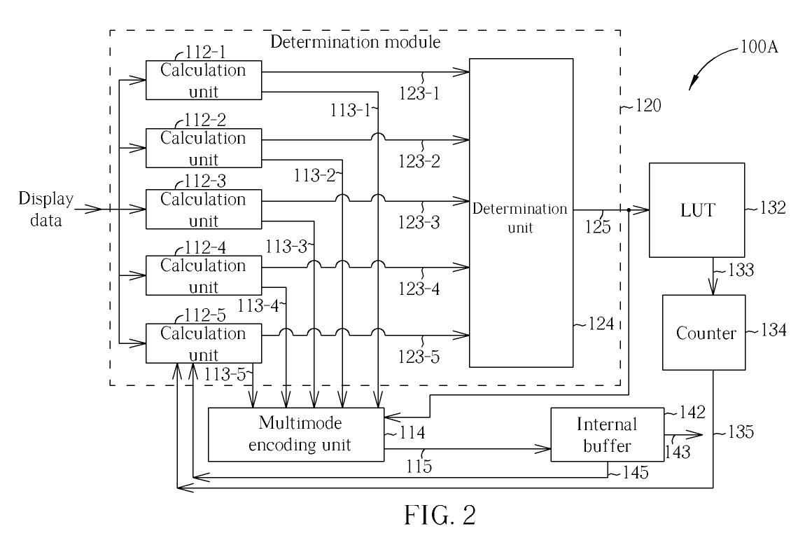

FIG. 2 illustrates an example of a circuit diagram of the multimode compressor 100A shown in FIG. 1. The multimode compressor 100A comprises a multimode encoding unit 114, a determination module 120, a look-up table (LUT) 132, a counter 134, and an internal buffer 142. The determination module 120 comprises a plurality of calculation units 112-1, 112-2, 112-3, 112-4 and 112-5 and a determination unit 124. For example, the internal buffer 142 can be a first-in first-out (FIFO) memory or a static random access memory (SRAM). The multimode compressor 100A receives display data to perform multimode compression. In this embodiment, five-mode compression cooperations with the calculation units 112-1, 112-2, 112-3, 112-4 and 112-5 corresponding to a plurality of compression modes M(1), M(2), M(3), M(4) and M(5), respectively.

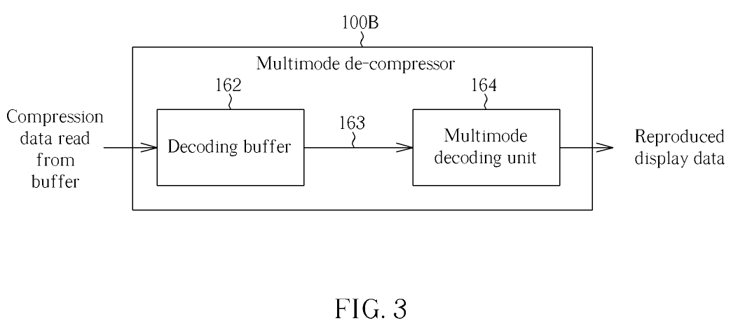

FIG. 3 illustrates an example of a circuit diagram of the multimode de-compressor 100B shown in FIG. 1. The multimode de-compressor 100B comprises a decoding buffer 162 and a multimode decoding unit 164. For example, the decoding buffer 162 can be a FIFO or an SRAM. Preferably, the size of the decoding buffer 162 is substantially equal to the size of the internal buffer 142 shown in FIG. 2. Compression data derived from the multimode compression is buffered in the buffer 101. The multimode de-compressor 100B performs corresponding decompression on the compression data read from the buffer 101, in order to generate reproduced display data for overdrive processing.

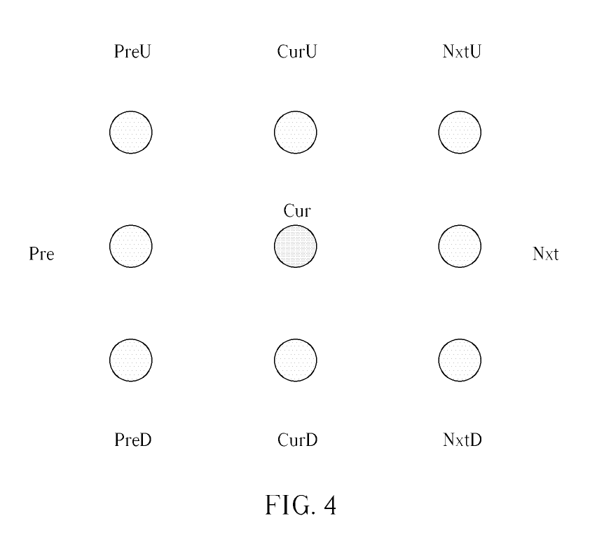

FIG. 4 illustrates pixels processed by a multimode-compressive overdrive method according to one embodiment of the present invention. The 3-by-3 pixels are designated as Pre, PreU, PreD, Cur, CurU, CurD, Nxt, NxtU and NxtD, where the pixel Cur represents a currently processed pixel. In view of the 3-by-3 pixels, the multimode compressor 100A shown in FIG. 2 may encode the pixel Cur according to a specific compression mode M(i) of the compression modes mentioned above.

For example, the compression mode M(1) can be a difference mode. When the differences between the pixel Cur and the other eight pixels are all small, these differences can be encoded as the compression data.

For example, the compression mode M(2) can be a two-pixel mode. When the pixel Cur is similar to one of the pixels Nxt, PreD, CurD or NxtD, the pixel Cur and the one of the pixels Nxt, PreD, CurD or NxtD can be encoded together to share some bits within the compression data.

For example, the compression mode M(3) can be an interpolation mode. The pixel Cur can be selectively encoded together with adjacent pixels by interpolation operation along one of three other directions.

For example, the compression mode M(4) can be a bit-saving mode. When consecutive pixels with the same value appear along a horizontal direction or a vertical direction, a special code associated with a pixel count can be utilized for encoding, in order to greatly save DRAM and reduce the access traffic of DRAM, i.e. the buffer access bandwidth of this embodiment. More particularly, this mode is advantageous for some single-colored pictures such as all-black pictures or all-white pictures.

For example, the compression mode M(5) can be a variable-sized compression mode. When the storage space of the buffer 101 is sufficient, whether to utilize the compression mode M(5) can be determined according to compression errors. For instance, when the compression results of the compression modes M(1), M(2), M(3) and M(4) mentioned above are determined to be improper for compressing some pixels, i.e. the compression errors associated with the four compression modes are too large, the compression mode M(5) can be applied. In the compression mode M(5), even complete pixel data, such as red, green and blue data, can be stored. Completely storing raw data provides an intact previous frame for overdrive processing. It should be noted that the compression mode M(5) consumes lots of DRAM space. Therefore, the compression mode M(5) can be applied when the remaining space of DRAM is sufficient.

Please refer to FIG. 2 again. The counter 134 generates a counter value for counting the bit rate of a multimode buffering operation. For example, the multimode compressor 100A may utilize the compression mode M(i) (i=1, 2, . . . , 5) to perform trial compression on the display data, and then encoding according to an intermediate calculation result carried by a signal 113-i. The remaining space of the buffer 101 during operations varies according to a storage space difference DV(i) corresponding to the compression mode M(i). If the storage space difference DV(i) is positive, the remaining space increases as time goes by. If the storage space difference DV(i) is negative, the remaining space decreases as time goes by. If the storage space difference DV(i) is zero, the remaining space keeps unvaried as time goes by.

As the algorithm of compression modes M(i) is known during circuit design, the storage space difference DV(i) can be derived from theoretical calculations or trial experiments in advance. Therefore, the storage space difference DV(i) corresponding to the compression mode M(i) can be stored in the LUT 132 in advance. According to the display data, the determination module 120 dynamically determines, among the plurality of compression modes M(i) (i=1, 2, . . . , 5), a compression mode M(i₀) suitable for compressing the display data, where i₀ represents a determined value. In addition, the determination module 120 outputs the index value i₀ representing the determined compression mode M(i₀) through a signal 125 to the LUT 132.

In this embodiment, the calculation units 112-1, 112-2, 112-3, 112-4 and 112-5 calculate a plurality of image error values respectively corresponding to the compression modes M(i) according to the display data, where the image error values represent image compression errors of the compression modes regarding the currently encoded pixel Cur, respectively. In addition, each calculation unit 112-i (i=1, 2, . . . , 5) outputs the corresponding estimation value through a signal 123-i to the determination unit 124, and the determination unit 124 generates a best-compression mode signal 125 according to the compression errors to determine, within the compression modes M(i) (i=1, 2, . . . , 5), the compression mode M(i₀) suitable for compressing the display data. For example, the image compression errors of the compression modes regarding the currently encoded pixel Cur can be estimated by calculating absolute sums of differences between images before and after compression. More particularly, as shown in FIG. 4, the 3-by-3 pixel matrix is applied for compression estimation. For example, the determination unit 124 may select the compression mode having the minimal image compression error and enable the multimode encoding unit 114 to perform compression for the selected mode through the best-compression mode signal 125 and generate the compression data. The compression mode M(i₀) determined by the determination module 120 is applied for accessing the LUT 132 to obtain the storage space difference DV(i) corresponding to the selected compression mode M(i), for being counted or accumulated by the counter 134.

For example, an initial value of the counter 134 is set as an initial value of the remaining space size of the buffer 101, which is provided to the counter 134 through a register (not shown). Thus, the present invention provides system manufacturers with the flexibility of optimizing their own systems regarding different external DRAM sizes. By dynamically counting the storage space difference DV(i) mentioned above (i=1, 2, . . . , or 5), the counter 134 may generate the counter value representing the bit rate, where the storage space difference DV(i) can be an increment or a decrement of the counter value. As a result, the multimode-compressive overdrive circuit 100 may dynamically determine whether to enable a specific compression mode of the compression modes, e.g. a certain one of the compression modes M(i), according to the counter value, in order to optimize the compression quality and the storage space utilization of the buffer 101. Preferably, the counter 134 may control the calculation unit 112-5 corresponding to the compression mode M(5) through a signal 135 to enable or disable the compression mode M(5). Thus, the multimode compressor 100A performs bit-rate control during compression operations utilizing the counter 134 to control the remaining space of the buffer 101, in order to optimize the storage space utilization of the buffer 101 for all kinds of sizes of the buffer 101.

In this embodiment, a specific compression mode can be predetermined as needed. For example, the variable-sized compression mode M(5) is set as the best compression mode. When the remaining space of the buffer 101 is sufficient, the specific compression mode can be enabled. Since the variable-sized compression mode M(5) consumes lots of DRAM storage space, the compression mode M(5) is disabled when the remaining space of DRAM is below a threshold. For example, when the multimode-compressive overdrive circuit 100 utilizes the specific compression mode, the variable-sized compression mode M(5), to perform compression, the remaining space is determined as insufficient if the counter value decreases to a predetermined value PV1. In this situation, the multimode-compressive overdrive circuit 100 may temporarily disable the specific compression mode to release the DRAM space by switching to a compression mode that has a higher compression rate. Once the counter value increases up to a predetermined value PV2, the multimode-compressive overdrive circuit 100 may re-enable the specific compression mode.

The internal buffer 142 buffers the compression data and then transfers the compression data into the DRAM. Ideally, since both compression and decompression are performed simultaneously, the utilization of the internal buffer 142 should reach dynamic balance. However, the internal buffer 142 is limited and the variable-sized compression mode of the compression mode M(5) consumes lots of DRAM space. Preferably, the internal buffer 142 may control the calculation unit 112-5 corresponding to the compression mode M(5) through a signal 145 to enable or disable the compression mode M(5). Thus, the internal buffer 142 performs memory bandwidth control to the compression operations. If the DRAM access traffic is too high, the compression data consume the space of the internal buffer 142 very soon. In this situation, the internal buffer 142 disables, through the signal 145, the compression mode M(5) that consumes the DRAM storage space most. When the remaining space of the internal buffer 142 reaches a safe threshold, the internal buffer 142 re-enables the compression mode M(5).

Therefore, the multimode compressor 100A may dynamically determine whether to enable a specific compression mode according to the counter value and/or the data amount within the internal buffer 142, to optimize the bit-rate and the bandwidth so as to prevent the compressed image quality from being abruptly changed during the compression operations.

In FIG. 3, in accordance with the buffering processing architecture described above, a decoding buffer 162 corresponding to the internal buffer 142 is installed in the multimode de-compressor 100B to buffer the compression data read from the buffer 101, and can be utilized for dynamically adjusting the bandwidth of the buffer 101. By utilizing the buffering processing of the decoding buffer 162, the multimode de-compressor 100B utilizes the multimode decoding unit 164 to decompress the compression data correspondingly.

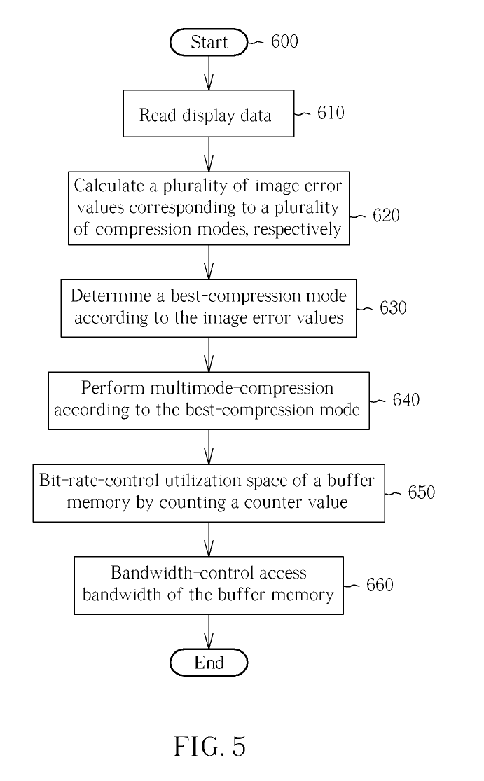

FIG. 5 is a flowchart of a multimode-compressive overdrive method according to one embodiment of the present invention. The flowchart starts with Step 600. In Step 610, display data is read. For example, in this step, matrix data of an M×N matrix is read from a display. In Step 620, with reference to the M×N matrix data, a plurality of image error values corresponding to a plurality of compression modes are calculated, respectively. In Step 630, a best-compression mode is determined according to the image error values. In Step 640, compression is performed according to the determined best-compression mode. In Step 650, the utilization space of a buffer memory is bit-rate-controlled by counting a counter value. For example, in this step, the counter is utilized to count the remaining space of the buffer memory. When the remaining space of the buffer memory is below a predetermined threshold, the compression mode that consumes the memory space the most among the compression modes is disabled. When the remaining space of the buffer memory reaches a safety threshold, the compression mode that is previously disabled is enabled. The counter value is adjusted with an increment or a decrement by referencing a look-up table according to the best-compression mode. In Step 660, the access bandwidth of the buffer memory is bandwidth-controlled. For example, in this step, two FIFOs with equal length are installed at the compression stage and the decompression stage, respectively. When the remaining space of the FIFO of the compression stage reaches a predetermined threshold, the compression mode that consumes the memory space the most among the compression modes is disabled. When the remaining space of the FIFO of the compression stage reaches a safety threshold, the operation of the compression mode is enabled. Furthermore, in this step, the FIFO of the decompression stage is utilized to read the compression data for multimode decompression, which can also provide DRAM space release information for multimode compression to count the remaining buffer space.

The present invention overdrive circuit and method dynamically controls the bandwidth of the buffer 101 by utilizing the virtual buffering architecture. Therefore, the present invention overdrive circuit and method can share the processing load during non-blanking intervals and blanking intervals, i.e. vertical blanking intervals and horizontal blanking intervals. Therefore, the overall performance of the overdrive circuit can be optimized regarding time line.

It is another advantage of the present invention that the present invention overdrive circuit and method can dynamically adjust the storage bit rate of the buffer 101 by utilizing the counter and the LUT, in order to optimize the storage space utilization of the buffer 101.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A multimode-compressive overdrive circuit comprising:
a plurality of calculation units, for receiving display data, and generating a plurality of image error values corresponding to a plurality of compression modes;
a determination unit, coupled to the calculation units, for generating a best-compression mode signal; and
a multimode encoding unit, coupled to the determination unit, for multimode-compressing the display data to generate compression data in response to the best-compression mode signal.

2. The overdrive circuit of claim 1, further comprising:
an internal buffer, coupled to the multimode encoding unit, for buffering the compression data.

3. The overdrive circuit of claim 2, wherein the internal buffer is coupled to one of the calculation units to dynamically determine whether to enable a specific compression mode of the compression modes according to a remaining space size of the internal buffer.

4. The overdrive circuit of claim 2, wherein the internal buffer is a first-in first-out (FIFO) memory.

5. The overdrive circuit of claim 2, wherein the internal buffer is a static random access memory (SRAM).

6. The overdrive circuit of claim 1, further comprising:
a counter for generating a counter value to count a bit rate of a buffering operation.

7. The overdrive circuit of claim 6, further comprising:
a look-up table (LUT), coupled between the counter and the determination unit, for providing the counter with an increment or a decrement in response to the best-compression mode signal.

8. The overdrive circuit of claim 6, wherein the counter is coupled to one of the calculation units to dynamically determine whether to enable a specific compression mode of the compression modes in response to the counter value.

9. The overdrive circuit of claim 8, wherein when the counter value reaches a predetermined value, the counter disables the specific compression mode.

10. A multimode-compressive overdrive method comprising:
reading display data;
calculating a plurality of image error values corresponding to a plurality of compression modes, respectively;
determining a best-compression mode according to the image error values; and
performing compression according to the best-compression mode to generate compression data.

11. The method of claim 10, further comprising the step of:
bit-rate-controlling a utilization space of a buffer by counting a counter value.

12. The method of claim 11, wherein the bit-rate-controlling step further comprises:
dynamically determining whether to enable a specific compression mode of the compression modes in response to the counter value.

13. The method of claim 11, wherein the counter value is adjusted with an increment or a decrement by referencing a look-up table according to the best-compression mode.

14. The method of claim 10, further comprising the step of:
bandwidth-controlling an access bandwidth of a buffer.

15. The method of claim 10, further comprising the steps of:
buffering the compression data into a first-in first-out (FIFO) memory; and
bandwidth-controlling a buffer access bandwidth.

16. The method of claim 15, wherein the bandwidth-controlling step further comprises:
dynamically determining whether to enable a specific compression mode of the compression modes according to a remaining space size of the FIFO memory, in order to bandwidth-control the buffer access bandwidth.

17. The method of claim 15, further comprising the steps of:
utilizing another FIFO memory to read the compression data; and
multimode-decompressing the compression data.
